(19) United States
(12) Patent Application Publication
(10) Pub. No.: US 2016/0083936 A1
(43) Pub. Date: Mar. 24, 2016

(54) Harvesting and Purification of Water From A Vehicle

(71) Applicant: Ford Global Technologies, LLC, Dearborn, MI (US)

(72) Inventors: Douglas Raymond Martin, Canton, MI (US); Kenneth James Miller, Canton, MI (US); Kenneth J. Jackson, Dearborn, MI (US)

(21) Appl. No.: 14/490,744

(22) Filed: Sep. 19, 2014

(51) Int. Cl. E03B 3/28; B01D 5/00; C02F 1/02

(52) U.S. Cl. CPC E03B 3/28; C02F 1/02; B01D 5/0075; B01D 5/0072; C02F 2209/42; C02F 2209/02; C02F 2307/00

(57) ABSTRACT

A water harvesting and purifying system and method for an automobile. The system automatically collects condensed water from a heat-exchanger in an air-conditioning system. the system filters the condensed water and isolates it in a reservoir. the system boils the isolated water to further purify. The water is then useful for drinking for a predetermined time period, after which the water is purged and the process restarted.

### TECHNICAL FIELD

This disclosure relates to water harvesting systems integrated in a vehicle, and more specifically to purification of the harvested water and harvesting of the water when the vehicle is keyed-off.

### BACKGROUND

Clean drinking water is not readily available in arid locations, especially for travelers. The cost of infrastructure to provide clean drinking water in arid locations by traditional underground piping may be prohibitive. One solution has been to use stationary water harvesting stations, such as a water-making billboard, to condense water from the air and make it available for drinking.

The concept of harvesting water from vehicle air-conditioning systems has been disclosed in prior art references, however no automotive manufacturer has provided such a system on a vehicle to date. The prior art discloses the harvesting of water from air-conditioning systems when the vehicle is being driven and the air-conditioning is being used to cool the passenger compartment. There exists a need for a water purification system that may provide clean drinking water in a simple cost effective design. In addition, there exists a need for a vehicle based system that may harvest water while the vehicle is not being driven.

### SUMMARY

One aspect of this disclosure is directed to a system for harvesting clean drinking water in a vehicle. The system includes a heat-exchanger, a reservoir fluidly connected with the heat-exchanger and configured to collect water from the heat-exchanger, and a heating element configured to heat water within the reservoir. This system includes a controller coupled with the heating element and programmed to boil the water in the reservoir.

The system may include a water level sensor disposed within the reservoir. The controller may be further programmed to boil the water in response to the water in the reservoir reaching a predetermined level. The system may also include a valve fluidly disposed between the heat-exchanger and the reservoir. The controller may be coupled with the valve and further programmed to, in response to the water in the reservoir reaching the predetermined level, actuate the valve to inhibit water flow from the heat-exchanger to the reservoir.

The system may have a temperature sensor disposed in the reservoir. The controller may be coupled with the temperature sensor and further programmed to, in response to the water having a temperature indicative of boiling, maintain the temperature of the water for a predetermined period of time. The predetermined time period may be at least one minute. The controller may also be programmed to purge the water in the reservoir after a second predetermined period of time elapsing from the water having a temperature indicative of boiling. The second predetermined period of time may be at least 12 hours.

The system may have a display. The controller may be programmed to send information relating to the purging of the water in the reservoir to the display. The system may have an air duct proximate the reservoir to facilitate cooling of the water after being boiled. The system may also have a temperature sensor in the reservoir. The controller may be further programmed to, in response to the water reaching a predetermined temperature below a temperature indicative of boiling, indicate that the water is ready to drink.

The system may include a dispensing line and a water bottle compartment capable of holding at least one water bottle. The controller may be programmed to fill at least one water bottle. The heat-exchanger may be a condenser.

The system may be part of a vehicle that has a battery capable of being recharged by plugging it in to an external electric source. The heat-exchanger may be part of an air-conditioning system of such a vehicle capable of being operated by the battery. The controller may be coupled with the battery and the air-conditioning system and further programmed, in response to the battery being recharged by the external electric source, operate the air-conditioning system to generate water from the heat-exchanger.

Another aspect of this disclosure is directed toward a method of providing clean drinking water in a vehicle. The method includes a step of operating an air-conditioning system during a key-off time period. The method also includes the step of collecting the condensed water from a condenser in the air-conditioning system, and then boiling the condensed water.

The step of collecting condensed water may include collecting a predetermined amount of condensed water, and isolating the collected amount of condensed water from additional waters that may condense off of the condenser. The method may include filtering the condensed water. The method may include purging the boiled water after a predetermined time period. Alternatively, the method may include re-boiling the boiled water after the predetermined time period. The time period may be at least 12 hours.

The step of operating an air-conditioning system during a key-off period may include providing an external power source to the vehicle.

The above aspects of this disclosure and other aspects will be explained in greater detail below with reference to the attached drawings.

### BRIEF DESCRIPTION OF THE DRAWINGS

FIG. 1 is a diagrammatic illustration of a vehicular water harvesting and purification system.

FIG. 2 is a flowchart illustrating an example of automatic water harvesting.

FIG. 3 is a flowchart illustrating an example of automatic water purification.

### DETAILED DESCRIPTION

The illustrated embodiments are disclosed with reference to the drawings. However, it is to be understood that the disclosed embodiments are intended to be merely examples that may be embodied in various and alternative forms. The figures are not necessarily to scale and some features may be exaggerated or minimized to show details of particular components. The specific structural and functional details disclosed are not to be interpreted as limiting, but as a representative basis for teaching one skilled in the art how to practice the disclosed concepts.

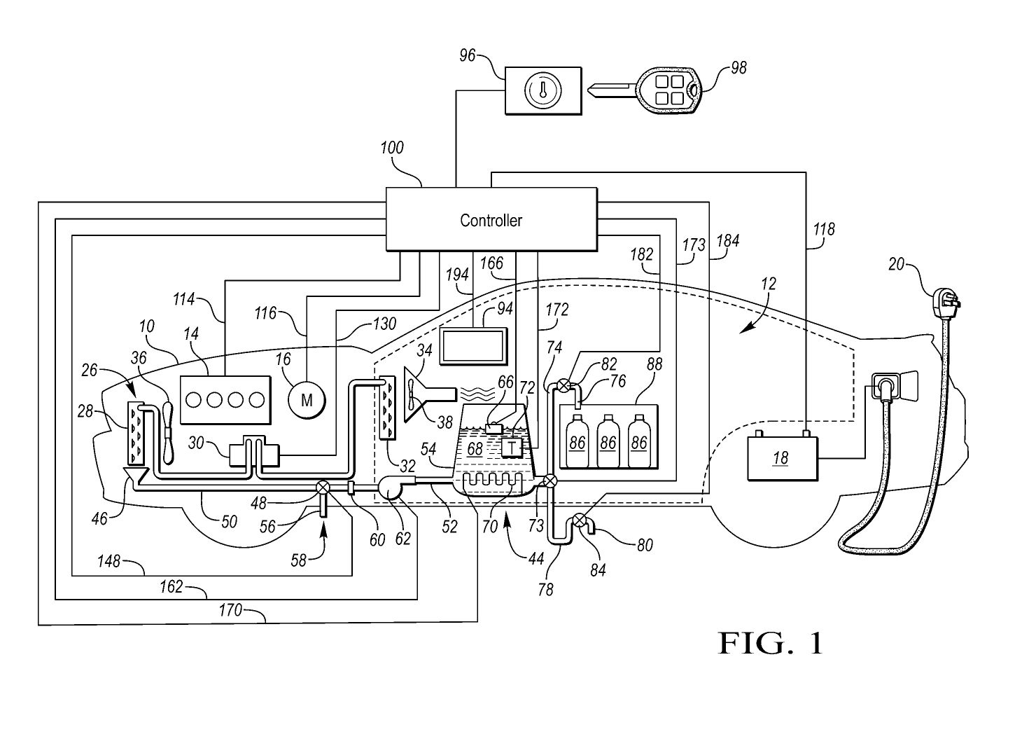

FIG. 1 shows a vehicle 10 having a passenger compartment 12. Vehicle 10 may be a vehicle with an engine 14, an electric machine 16, or both cooperating as a prime mover of the vehicle. The Engine 14 and electric machine 16 represent any machine designed to convert energy into useful mechanical motion. The engine 14 may be a gasoline engine, a diesel engine or any form of an internal combustion engine that burns fuel. The electric machine 16 may be an electric motor. As such, the vehicle may be a traditional engine only vehicle, a battery-only electric vehicle (BEV), or may be a hybrid electric vehicle (HEV).

The vehicle 10 may have a battery 18. The battery 18 may be a high voltage traction battery that coupled with the electric machine 16 may provide the energy for the electric machine to provide motion. The vehicle 10 may have a plug-in cable 20. The plug-in cable 20 is configured to connect the battery 18 to an external power source (not shown). Thus battery 18 is capable of being recharged by plugging the plug-in cable 20 into an external power source.

Vehicle 10 has an air-conditioning system 26. The air-conditioning system 26 has a heat-exchanger 28 disposed outside of the passenger compartment 12, a compressor 30, and a heat-exchanger 32 disposed within the passenger compartment 12. The heat exchanger 28 located outside of the passenger compartment 12 may be referred to as a condenser 28. The heat exchanger 32 located within the passenger compartment 12 may be referred to as an evaporator 32. The compressor 30 may be driven by the engine 14, such as by the use of an auxiliary drive belt off a crankshaft (not shown), or an auxiliary drive belt off the electric machine 16, or by having a separate compressor motor (not shown). The compressor motor may be provided energy from the high voltage traction battery 18 or from a 12 volt battery (not shown).

Other components of an air-conditioning system 26 may be present in the system, such as a pressure regulator, an expansion valve, an accumulator, a receiver, a desiccant filter, or the like. The air-conditioning system 26 may also include an electronic control system (not shown) and a series of ducts 34 to route conditioned air from the evaporator 32 into the passenger compartment 12. A fan 36 may be employed adjacent the heat-exchanger 28 to aid in improved airflow across heat-exchanger 28. A second fan 38, or a group of fans 38, may be disposed within the series of ducts 34 to aid in airflow across the heat-exchanger 32.

As a vehicle air-conditioning system 26 runs, water may condense on the heat exchangers 28, 32. Condensation is generally known as a change in the state of water vapor to liquid water when in contact with any surface. Generally when the air-conditioning system 26 is used to cool the passenger compartment, condensation may occur on the heat-exchanger 28 disposed outside of the passenger compartment 12, although condensation may occur on the heat-exchanger 32 located within the passenger compartment as well. The heat-exchanger 28 located outside of the passenger compartment 12 is in fluid contact with the ambient environment (or an equivalent environment within an engine compartment adjacent the ambient environment. The water that condenses on heat-exchanger 28 is from water vapor formerly held within air surrounding the heat-exchanger 28.

Vehicle 10 has a water harvesting and purification system 44. A collector 46 is located near the heat-exchanger 28 and is configured to collect condensed water from the heat-exchanger 28. The collector may be located below the heat-exchanger 28 and gravity may be used to collect the water. The collector 46 may be fluidly connected to a collection valve 48 via a collector line 50. Collection valve 48 may be a three-way valve, or a series of T-shaped valves. Collection valve 48 may also be an electric actuated valve 48. Collection valve 48 may be used to divert water from the collector 46 to a first fluid flow path 52 allowing water to flow from the heat-exchanger 28 to a reservoir 54. Said another way, the collection valve 48 may be fluidly disposed between the heat-exchanger 28 and the reservoir 54. Collection valve 48 may also be used to divert water from the collector 46 to a second fluid flow path 56 allowing water to flow from the heat-exchanger 28 to a drain 58 and outside of the vehicle 10.

The first fluid flow path 52 may include a filter 60. The filter 60 may be a mesh screen which is used for the separation of solids from fluids by interposing a medium through which the fluid can pass but not solids larger than the mesh sizing. The filter 60 may also be a chemical or ultraviolet filtration device which may be used to filter out undesirable bacteria, organic carbons, or the like. The filter 60 may be a number of filters 60. The first fluid flow path 52 may also include a pump 62. The filter 60 may be located before or after the pump 62. The filter 60 may also be located before the collection valve 48. Likewise, the pump 62 may also be located before the collection valve 48. The system may also operate without a filter 60 or pump 62, or provide more than one filter 60 or pump 62 at any location within the harvesting and purification system 44 to provide desired filtration, to move water, or to provide pressure where desired. Thus the filter 60, if used, may be fluidly disposed between the heat-exchanger 28 and the reservoir 54.

The reservoir 54 is fluidly connected with the heat-exchanger 28 such that the reservoir 54 is configured to collect water from the heat-exchanger 28. The reservoir 54 may be located inside or outside of the passenger compartment 12. The reservoir 54 may have a water level sensor 66. The water level sensor 66 may be a float 66 disposed within the reservoir 54 which floats on accumulated water 68 within the reservoir 54. The reservoir 54 may have a heating element 70 configured to heat the accumulated water 68. The heating element 70 may be disposed within the water 68, or may be disposed in a wall of the reservoir 54. The accumulated water 68 may also be pre-heated by having the collector line 50 or first fluid flow path 52 warmed by other heat generating sources. For example, the collector line 50 may pass through or near the engine 14.

The reservoir 54 has a temperature sensor 72 configured to provide a temperature of the accumulated water 68. The temperature sensor 72 may be submerged in the water 68, may be in a wall of the reservoir 54, or may be part of the heating element 70. The heating element 70 may be used to heat the accumulated water 68. The heating element 70 may be used to boil the accumulated water 68. The boiling of the water 68 may be done to remove additional impurities. The air-conditioning system 26 may be used to add heat to the water 68. After heating of the water 68, ducts 34 from the air-conditioning system 26 may be used to cool the water 68. A duct 34 of the multiple ducts 34 may be located proximate the reservoir 54 configured to facilitate cooling of the water 68. Additional cooling devices (not shown) may be used to cool the water 68 after being boiled.

The reservoir 54 may have an outlet valve 73. The outlet valve 73 may be a three way valve similar to the collection valve 48. The outlet valve 73 may be actuated to allow the water 68 to flow out of the reservoir 54. A first dispensing line 74 may extend from the outlet valve 73 to a first spout 76 in the passenger compartment 12. A second dispensing line 78 may extend from the outlet valve 73 to a second spout 80 outside of the passenger compartment 12. The reservoir 54 may be disposed within or outside of the passenger compartment 12. The first spout may be opened and closed by a first dispensing valve 82. The second spout 80 may be opened and closed by a second dispensing valve 84. The first and second valves 82, 84 may be manual valves or electric actuated valves.

The first spout 76 may be configured to fill at least one water bottle 86. The water bottle 86 may be located within a water bottle compartment 88. The water bottle 86 may be a 12 ounce water bottle and the water bottle compartment 88 may be able to hold six water bottles 86. The water bottle compartment 88 may be sized to fit six water bottles 86, three wide and two deep. The first spout 76 may be moveable via a first spout motor (not shown) to fill each water bottle 86. Alternatively, the water bottles 86 may be on a rotatable tray or conveyor tray and each moveable to the first spout 76. The water bottle compartment 88 may be cooled by a duct 34 from the number of ducts 34 of the air-conditioning system 26. The water bottle compartment 88 may also be heated by a duct 34 from the number of ducts 34 of the air-conditioning system 26. The water bottle compartment 88 may be cooled by a separate refrigeration unit (not shown). The water bottle compartment 88 may be disposed in a dash panel or instrument panel adjacent, or in place of, a glove compartment. The system 44 provides a removable bottle 86 with purified water within reach of a driver of the vehicle 10.

The water harvesting and purification system 44 may also have a display 94 for relating information about the water harvesting and purification system 44 to a user. Information may include such data as amount or temperature of the accumulated water 68 in the reservoir 54, whether the accumulated water 68 has been purified, time elapsed since the accumulated water 68 has been purified, or the like. The display 94 may be located in a location visible to a user in the passenger compartment 12. The display 94 may be an existing display in an infotainment system (not shown). The display 94 may be located in a location visible to a user outside of the passenger compartment 12. An exterior display 94 may be within the passenger compartment 12 visible through a window, may be a projector that projects the data onto a window, or may be a series of lights in the exterior surface of the vehicle 10.

An ignition 96 may be connected to the vehicle 10. The ignition 96 may be controlled by a user to key-on and start the vehicle 10. When the vehicle 10 is key-on and started, either the engine 14, motor 16, or both may be used to propel the vehicle 10. As well, in the key-on state, the air-conditioning system 26 may be used to cool the vehicle and provide condensed water for the water harvesting and purification system 44. The user may also use the ignition 96 to key-off and stop the vehicle 10. The engine 14 and motor 16 may not propel the vehicle in a key-off state. A traditional key 98 is shown that may be inserted into the ignition 96 and used to key-on and key-off the vehicle 10, however the ignition may not need an inserted key 98, as it may be a button or have a proximity key, or the like.

The water harvesting and purification system 44 may operate the air-conditioning system 26 to generate condensed water even when the vehicle 10 is in a key-off state. The water harvesting and purification system 44 may operate the air-conditioning system 26 to generate condensed water even when the vehicle 10 has the plug-in cable 20 plugged into an external power source to recharge the battery 18. The water harvesting and purification system 44 may utilize the external power source to provide the energy necessary to operate the air-conditioning system 26 while the vehicle 10 is key-off.

A controller 100 may automate the water harvesting and purification system 44. The controller 100 may be coupled with the engine 14, if one is in the vehicle 10, as indicated by communication line 114. The controller 100 may be coupled with the motor 16, if one is in the vehicle 10, as indicated by communication line 116. The communication lines 114, 116 may communicate data to the controller 100 such as current use of the engine and/or motor 14, 16, among others.

The controller 100 may be coupled with the battery 18, as indicated by communication line 118. The communication line 118 may communicate data such as current state of charge, battery charge level, or whether the battery 18 is being recharged by an external power source (via plug-in cable 20), among others. The controller 100 may be coupled with the compressor 30, as indicated by communication line 130. Communication line 130 may include data about the operation of the air-conditioning system 26, as well as provide a conduit for the controller 100 to control the operation of the compressor 30. The communication line 130 may also convey electrical current from the battery 18 to operate the compressor 30 when the engine 14 or motor 16 are not in use. The controller 100 may be coupled with the air-conditioning system 26, via the compressor 30, and programmed to, in response to the battery 18 being charged by an external electric source, operate the air-conditioning system 26 to generate water from the heat-exchanger 28.

The controller 100 may be coupled with the collection valve 48, as indicated by communication line 148. The controller 100 may be programmed to actuate the control valve 48 to switch from the first fluid flow path 52 to the reservoir 54 or the second fluid flow path 56 to the drain 58. The controller 100 may be programmed to, in response to the water 68 in the reservoir 54 reaching a predetermined level, actuate the control valve 48 to inhibit water flow from the heat-exchanger 28 to the reservoir 54. The controller 100 may be programmed to, in response to the water 68 in the reservoir 54 reaching a predetermined level, switch the collection valve 48 from the first fluid flow path 52 to the second fluid flow path 56. The controller 100 may be programmed to, in response to the water 68 in the reservoir 54 reaching a predetermined level, turn off the air-conditioning system 26 if being run during key-off/plug-in state.

The controller 100 may be coupled with the water level sensor 66, as indicated by communication line 166. The communication line 166 may convey data relating to the level of water 68 in the reservoir 54. The communication line 166 may convey the water 68 in the reservoir 54 reaching a predetermined level. The predetermined level may be different for each programmed operation. The predetermined level may be at least 12 ounces. The predetermined level may be greater than 72 ounces (enough to fill six 12 ounce bottles). The controller 100 may be coupled with the pump 62 via communication line 162. The controller 100 may be programmed to actuate pump 62 to move water or provide pressure within the water harvesting and purification system 44. The controller 100 may utilize the pump 62 to provide the pressure needed for the water 68 to reach the predetermined level.

The controller 100 may be coupled with the heating element 70 via communication line 170. The controller 100 may utilize the heating element 70 to heat the water 68. The controller 100 may utilize the heating element 70 to boil the water 68. The controller 100 may be programmed to, in response to the water 68 in the reservoir 54 reaching a predetermined level, boil the water 68. The controller 100 may be coupled with a temperature sensor 72 via communication line 172. The controller 100 may be programmed to, in response to the water 68 having a temperature indicative of boiling, maintain the temperature of the water for a predetermined period of time. The predetermined time period may be at least one minute. The controller 100 may be further programmed to, in response to the water reaching a predetermined temperature below a temperature indicative of boiling, indicate that the water 68 is ready to drink.

The controller 100 may be coupled with the outlet valve 73 via communication line 173. The controller 100 may actuate the outlet valve 73 to provide water to the first or second fluid flow paths 74, 78, or to maintain water 68 in the reservoir 54 until purified or until at a desired temperature. The controller 100 may be coupled with the first dispensing valve 82 via communication line 182. the controller 100 may be programmed to open the first dispensing valve 82 to automatically fill a water bottle 86. Alternatively, a user may initiate the opening and closing of the first dispensing valve 82 by a touch sensitive button, or the like (not shown).

The controller 100 may be coupled with the second dispensing valve 84 via communication line 184. the controller 100 may be programmed to open the second dispensing valve 84 to automatically purge water from the reservoir. Alternatively, a user may initiate the opening and closing of the second dispensing valve 84 by a touch sensitive button, or the like (not shown). The second dispensing valve 84 in conjunction with the second spout 80 provide an option of filling up any container outside of the vehicle 10.

The controller 100 may be further programmed to purge the water 68 in the reservoir after a second predetermined period of time elapsing from the water having a temperature indicative of boiling. The second predetermined period of time may be at least 12 hours. The controller may be coupled with the display 94 via communication line 194. The controller 100 may be programmed to display information on the display 94. The display 94 may display information relating to the purging of the water 68, such as a countdown until the next purge. The display 94 may also show information relating the amount or temperature of the accumulated water 68 in the reservoir 54, whether the accumulated water 68 has been purified, time elapsed since the accumulated water 68 has been purified, number of water bottles 86 filled, different operating parameters of the system, or the like.

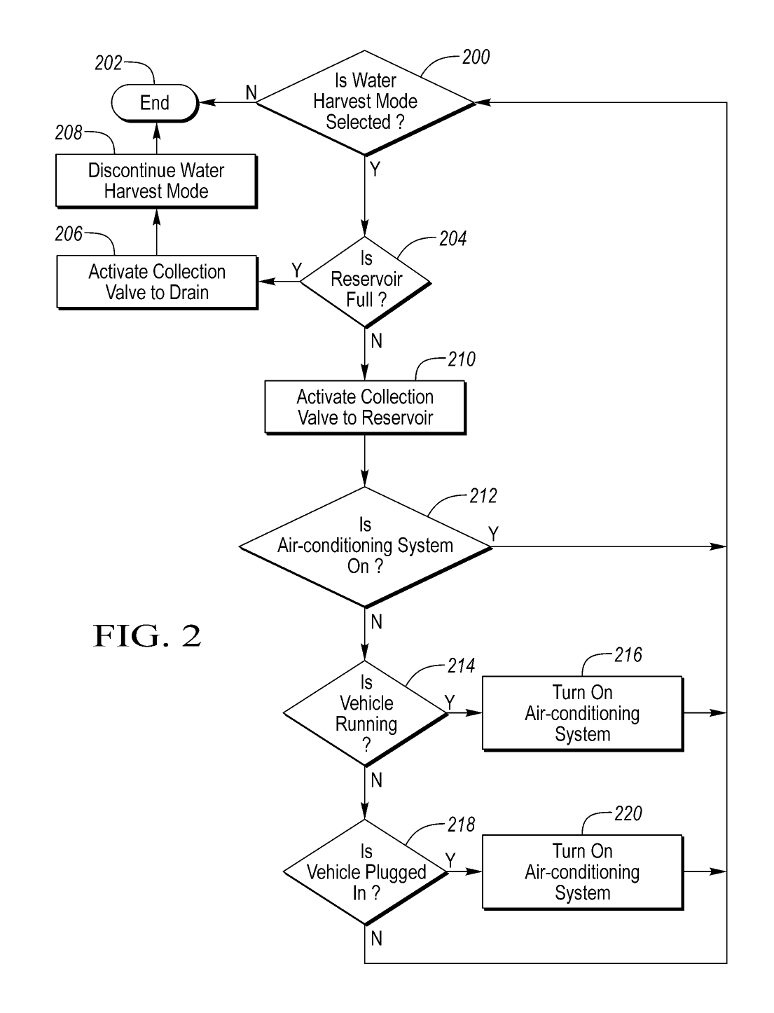

FIG. 2 shows an example of control logic, utilizing the above disclosed components, for the harvesting of water. Decision diamond 200 determines whether a water harvest mode has been selected by a user. If no water harvest mode has been selected, the logic flow moves to end block 202. Decision diamond 200 allows the automatic harvesting of water to be turned off. If the water harvest mode has been selected, the flow moves to decision diamond 204.

Decision diamond 204 determines whether water in a reservoir has reached a predetermined level. The predetermined level may be a full line. If the reservoir is full, the logic flow moves to action block 206, then to action block 208, and then to end block 202. Action block 206 actuates a collection valve to send any water condensed off a heat-exchanger to a drain. Action block 208 discontinues the water harvest mode. Action block 208 will turn off any and all other action blocks in this strategy flow diagram. If the reservoir is not full, the logic flow moves to action block 210.

Action block 210 actuates the collection valve to direct water from the heat-exchanger to the reservoir. The logic flow then moves to decision diamond 212 where it is determined whether an air-conditioning system is operating. If an air-conditioning system is operating, then the flow returns to decision diamond 200. This allows for a do-loop until the reservoir is filled or the water harvest mode is turned off by a user. If the air-conditioning system is not operating, the logic flow moves to decision diamond 214.

Decision diamond 214 determines whether the vehicle is running. If the vehicle is key-on and running, then the logic flow moves to action block 216. Action block 216 turns on the air-conditioning system and the flow returns to decision diamond 200. This allows for a do-loop in the logic flow until the reservoir is filled, the harvest mode turned off, or the vehicle turned off. If the vehicle is key-off, then the logic flow moves to decision diamond 218.

Decision diamond 218 determines whether the vehicle is plugged in to an external power source. If the vehicle is plugged in, then the logic flow moves to action block 220 and turns on the air-conditioning system to harvest water from the ambient air. The external power source provides the energy needed to run the air-conditioning system without draining a battery or gas tank. After action block 220, the logic flow returns to decision diamond 200. This allows for a do-loop in the logic flow until the reservoir is filled, the harvest mode turned off, the vehicle is unplugged, or the vehicle is keyed back on. If the vehicle is not plugged in, then the logic flow returns to decision diamond 200. This allows for a do-loop in the logic flow until the reservoir is filled, the harvest mode turned off, the vehicle is keyed back on, or the vehicle is plugged in.

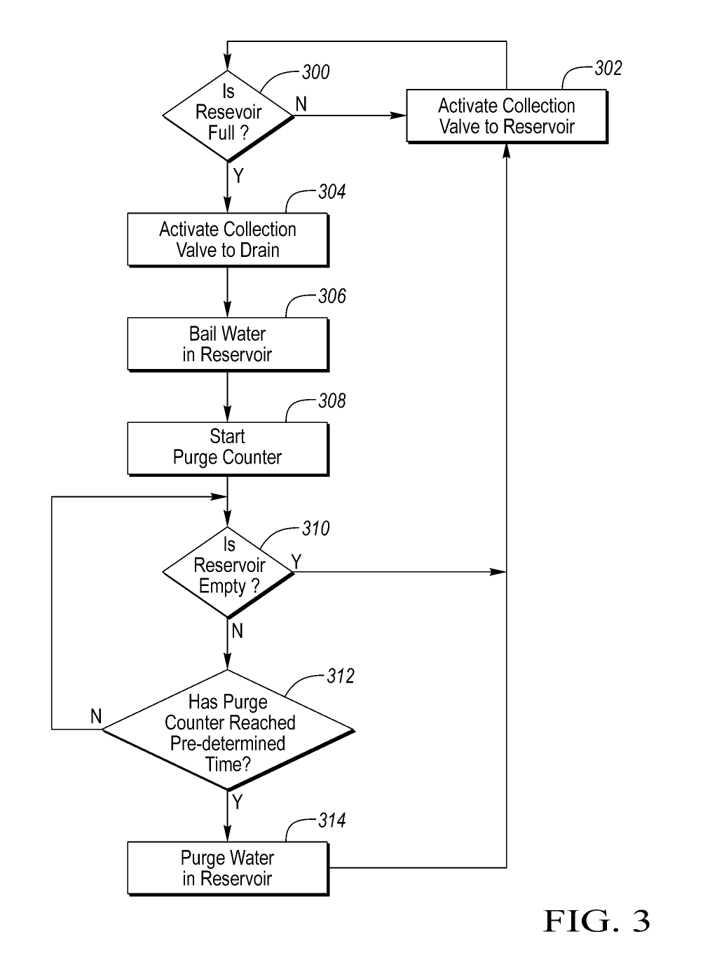

FIG. 3 shows an example of control logic, utilizing the above disclosed components, for the purification of water. Decision diamond 300 determines whether water in a reservoir has reached a predetermined level. The predetermined level may be a full line. If the reservoir is not yet full, the logic flow moves to action block 302. Action block 302 actuates a collection valve to send any water condensed off a heat-exchanger to the reservoir and then returns the logic flow to decision diamond 300. This provides a do-loop in the logic flow until the reservoir fills. If the reservoir is full, the logic flow moves to action blocks 304, 306, 308.

Action block 302 activates the collection valve to send water condensing off an evaporator to the drain and not to the reservoir. This allows for the water accumulated in the reservoir to be isolated. Action block 306 provides for the water in the reservoir to be brought to a boil. This allows for the water to be purified by the heat. Action block 306 may have a duration of at least one minute. Action block 308 starts a purge counter on the boiled water. after action blocks 304, 306, 308, the logic flow moves to decision diamond 310.

Decision diamond 310 determines whether the water in the reservoir has been emptied. If the water has been emptied, then the logic flow moves to action block 302 and back to decision diamond 300. This provides for a do-loop in the logic flow to allow the system to automatically fill itself and purify the accumulated water and refill itself and re-purify newly accumulated water so long as the older purified water has been discarded or used. If the reservoir still has some water remaining in it, then the logic flow moves to decision diamond 312.

Decision diamond 312 determines whether the purge counter has reached a predetermined time. In other words, it determines how much time has elapsed since the water was purified. The predetermined time may be at least 12 hours. If the predetermined time has not elapsed, then the logic flow returns to decision diamond 310. This allows for a do-loop in the logic flow until all of the water in the reservoir is discarded or used, or until the purge counter has reached its limit. If the purge counter has reached its limit, then the logic flow moves to action block 314. Action block 314 purges all of the water from the reservoir. This provides for the discarding of unused water and the prevention of the water in the reservoir from becoming un-purified. After action block 314, the logic flow returns to action block 302 and decision diamond 300. this allows for a do-loop in the logic flow to refill the reservoir and re-purify the water.

This logic flow chart may also include an action block of filtering the water (not shown) before or after action block 306 of boiling the water. The filtering of the water may include a mesh screen or other filtering techniques such as ultraviolet light or the like.

While exemplary embodiments are described above, it is not intended that these embodiments describe all possible forms of the disclosed apparatus and method. Rather, the words used in the specification are words of description rather than limitation, and it is understood that various changes may be made without departing from the spirit and scope of the disclosure as claimed. The features of various implementing embodiments may be combined to form further embodiments of the disclosed concepts.

What is claimed is:

1. A system for harvesting clean drinking water in a vehicle comprising:
a heat-exchanger;
a reservoir fluidly connected with and configured to collect water from the heat-exchanger;
a heating element configured to heat water within the reservoir; and
a controller coupled with the heating element and programmed to boil the water in the reservoir.

2. The system of claim 1 further comprising a water level sensor disposed within the reservoir, and wherein the controller is coupled with the water level sensor and further programmed to boil the water in response to the water in the reservoir reaching a predetermined level.

3. The system of claim 2 further comprising a valve fluidly disposed between the heat-exchanger and the reservoir, the controller coupled with the valve and further programmed to, in response to the water in the reservoir reaching the predetermined level, actuate the valve to inhibit water flow from the heat-exchanger to the reservoir.

4. The system of claim 1 further comprising a temperature sensor disposed in the reservoir, the controller coupled with the temperature sensor and further programmed to, in response to the water having a temperature indicative of boiling, maintain the temperature of the water for a predetermined period of time.

5. The system of claim 4 wherein the predetermined time period is at least one minute.

6. The system of claim 4 wherein the controller is further programmed to purge the water in the reservoir after a second predetermined period of time elapsing from the water having a temperature indicative of boiling.

7. The system of claim 6 wherein the second predetermined period of time is at least 12 hours.

8. The system of claim 6 further comprising a display wherein the controller is further programmed to send information relating to the purging of the water in the reservoir to the display.

9. The system of claim 1 further comprising an air duct proximate the reservoir to facilitate cooling of the water after being boiled.

10. The system of claim 9 further comprising a temperature sensor in the reservoir and the controller further programmed to, in response to the water reaching a predetermined temperature below a temperature indicative of boiling, indicate that the water is ready to drink.

11. The system of claim 1 wherein the vehicle has a battery capable of being recharged by plugging it in to an external electric source, the heat-exchanger is part of an air-conditioning system capable of being operated by the battery, and the controller is coupled with the air-conditioning system and the battery and further programmed, in response to the battery recharged by the external electric source, operate the air-conditioning system to generate water from the heat-exchanger.

12. The system of claim 1 further comprising a dispensing line, a water bottle compartment capable of holding at least one water bottle, and the controller further programmed to fill the at least one water bottle.

13. The system of claim 1 wherein the heat-exchanger is a condenser.

14. A method of providing clean drinking water in a vehicle comprising:
operating an air-conditioning system during a key-off time period;
collecting condensed water from a condenser in the air-conditioning system; and
boiling the condensed water.

15. The method of claim 14 wherein the step of collecting condensed water comprises:
collecting a predetermined amount of condensed water; and
isolating the collected amount of condensed water from additional waters that may condense off of the condenser.

16. The method of claim 14 further comprising:
re-boiling the boiled water after a predetermined time period.

17. The method of claim 14 further comprising:
purging the boiled water after a predetermined time period.

18. The method of claim 17 wherein the predetermined time period is at least 12 hours.

19. The method of claim 14 wherein the step of operating an air-conditioning system during a key-off period includes providing an external power source to the vehicle.

20. The method of claim 14 further comprising:
filtering the condensed water.
